(19) United States
(12) Patent Application Publication
(10) Pub. No.: US 2014/0020279 A1
(43) Pub. Date: Jan. 23, 2014

(54) Flea Trap with Advanced Attractant and Multiple Flea Killing Methods

(71) Applicant: Thomas Paul Cogley, Pinellas Park, FL (US)

(72) Inventor: Thomas Paul Cogley, Pinellas Park, FL (US)

(73) Assignee: Dr. Thomas Paul Cogley, Pinellas Park, FL (US)

(21) Appl. No.: 13/553,324

(22) Filed: Jul. 19, 2012

(51) Int. Cl. A01M 1/14

(52) U.S. Cl. CPC A01M 1/145
USPC 43/113; 43/121; 43/114

(57) ABSTRACT

The device is a flea trap device with multiple methods of killing and trapping the unwanted fleas.

The device utilizes a fake animal which moves via small vibrators under the fur, and is warm much like a real one. The feline's eyes light up.

This device utilizes heat, motion, and light to attract the fleas much like a real one. Also every so many minutes it.

sprays carbon dioxide on itself which is what is used to kill the fleas.

The animal has sticky tape around it which prevents the fleas from escaping or moving. Around the fake animal is a cage which prevents animals, and young ones from entering the trap.

This flea trap is the first one to utilize all methods of attracting fleas from a 360 degree angle.

### SUMMARY OF THE INVENTION

This invention is unique by incorporating multiple attracting methods and killing methods in one system. In addition, some of these methods have never been used to attract and deplete the flea population. It includes the following: 1) It has a structure that will mimic the silhouette of a mammal and will be referred to as the “form”. In the illustrations we give, we show a cat since the cat flea is the most prominent flea in the homes of the USA and affects dogs and cats. The silhouette is used by host seeking insect parasites in their early host seeking habit. The trap should be affective on all fleas and the “form” can be made of many different mammals including man. The silhouette is a new method; 2) this “form” will also show motion with the movement of the tail by a servo unit within it. Also, small vibrators are under the fur causing the fake animal to move up and down. Motion of the host is also used in early seeking methods by the insect parasites. The tail motion is a new method, 3) two fixed LED lights at 350 um are set stationary on the head one on each side of the “form”: These will mimic the eyes of the host and used by the parasite in long distance host seeking especially in the darkness of night. The LED linked with the silhouette is a new form, 4) A UV lamp of 325 um in motion will also be incorporated to attract fleas and used also in the production of carbon dioxide as discussed below when it is set in motion. The light will be set on the top of the tail itself that will eventually face downward onto the tail-base when it is brought upward by the servo unit. The tail-base will have the titanium coated plate that will produce carbon dioxide see below. Movement of the light attractant is a new method. 5) Carbon dioxide produced through UV light shown upon a metal plate painted with titanium dioxide a very important attractant too many insect parasites in seeking mammalian hosts that expel carbon dioxide. Carbon dioxide production by titanium is a new method for the flea but has been used for the mosquito. Its use in the form where the fleas are attracted to such as the flea base is novel. 6) A synchronous level of carbon dioxide even further appearing as a living and breathing mammal and quite unique among traps. The alternating level will follow the motion of the tail to and fro that has the UV light that beams upon the titanium plate. Synchronous production is a new method. 7) A heat strip that is applied to the form on its side and produces heat similar to that of the host; 8) The use of sticky material to capture and hold any flea that lands on it as it seeks the host; this material is placed as a circle below and surrounding the “form”. 9) Diatomaceous earth, a very safe insect killer operates by cutting the cuticle of the flea. The Diatomaceous earth is placed in a circle surrounding the smaller circle of sticky material. This reduces the flipping up of debris from the environment onto the sticky material and reducing the sticky stuff's affective surface to hold the flea. The material from the environment such as dust, hair and lint will not be as disturbing to the diatomaceous earth that is on the circle closest to the environment; this is a new method that will increase effectiveness. 10) If the flea does not jump into the diatomaceous earth or onto the sticky stuff as it tries to infest the “form” but instead reaches the form it will contact the man-made fur, powdered or saturated with a safe insecticide or any other that may be applied. This is a new method; 11) a circular fencing with the gap of fence known as rabbit wire will be used to keep true living pets from disturbing the device.

### BACKGROUND OF THE INVENTION

The invention has been developed by a Doctor of Veterinary medicine who has been dissatisfied with the use of insecticides on the animals and the environment. The inventor also holds a Doctor of Parasitology with a Masters in Entomology and has carried out many published works on the behavior of host seeking insect parasites in private practice and as an assistant professor.

This apparatus is particularly useful for the general public pet owners in reducing fleas and their ill effects that call for veterinary medicine. The device could also be used in scientific endeavors in the study of the flea and in public health to determine levels and disease probabilities, such as plague. It provides an alternative method to reduce flea infestation without using a widespread insecticide and without using insecticides on or within the pet. The insecticides have been losing the war with fleas and with greater potency of these insecticides ill effects are showing up in our pets and environment. It is a fact that for every flea taken out by this attractant and killing machine the need for pesticides if at all will be lessened. It is an economical, safe, and effective way to reduce flea infestation within the home.

The consumer needs a safe and easily used appliance to kill the fleas. This invention only requires the user to plug it into the wall and place some powder on the outer circle of the base. Of course there will be a necessity of removing the sticky material of the fleas it has captured on its surface. This would show the consumer all the fleas that no longer have the ability to torment them or their pet.

The present inventions for flea traps are lacking. They do not incorporate essential means to attract the flea at the optimum level.

### BRIEF DESCRIPTION OF THE DRAWINGS

FIG. 1 explains how the sticky stuff surrounding the animal silhouette is used to trap fleas and eliminate movement.

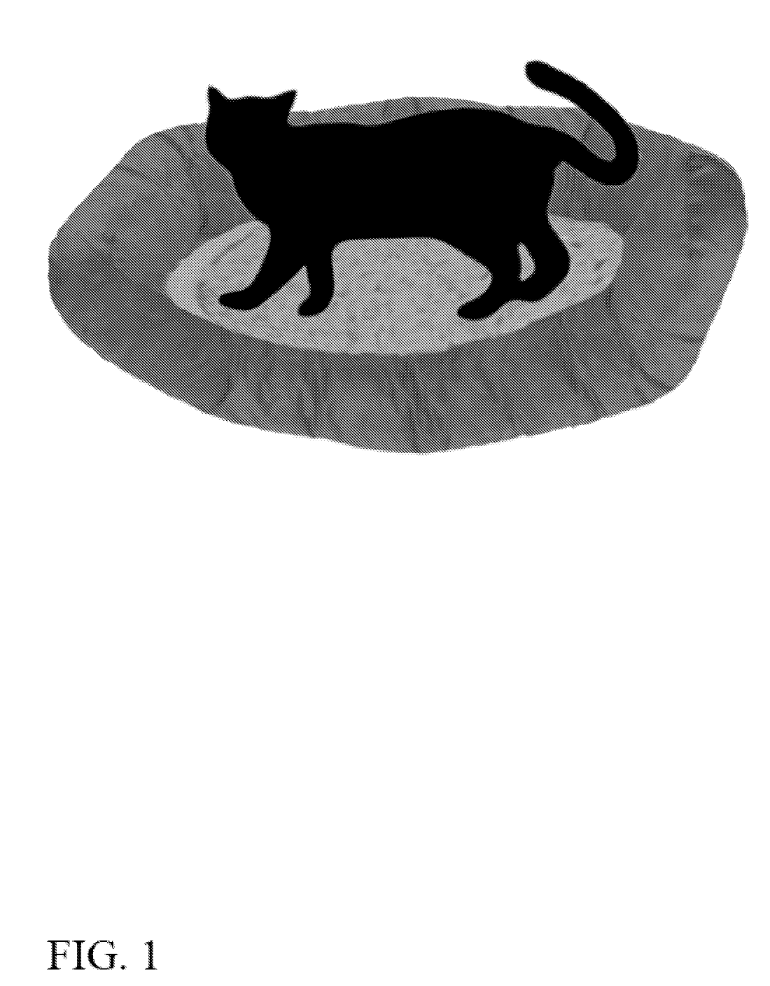

FIG. 2 explains that the fake animal will have a tail that moves. Also, it has small vibrators under the fur which causes fake breathing. This movement is one of the many ways that attracts fleas.

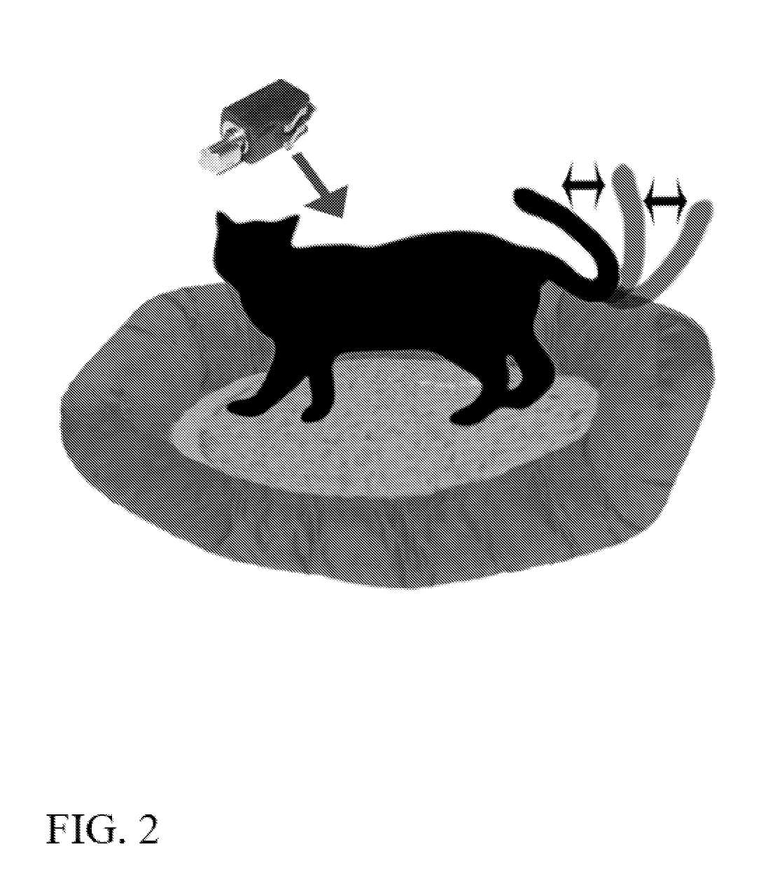

FIG. 3 explains how the fake animal will have led eyes and heat strips on the side of the fake animal. Light and heat are two methods that attract fleas. Our fake animal does just that.

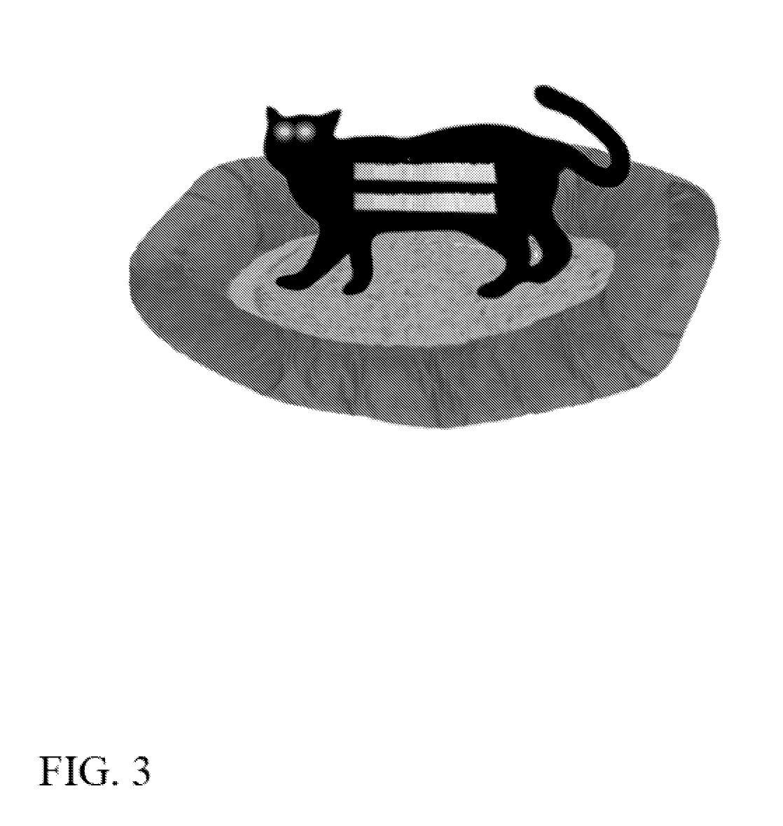

FIG. 4 explains how the fake animal will have a UV light reflecting on to a titanium plate producing carbon dioxide which also attracts fleas.

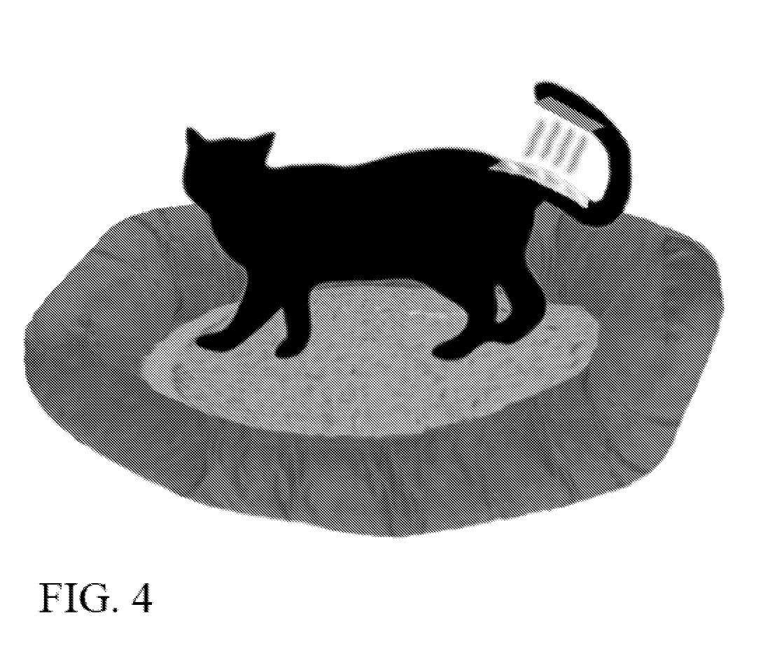

FIG. 5 explains how the fake animal and bed will be surrounded by a small cage which will prevent unwanted animals from entering the trap.

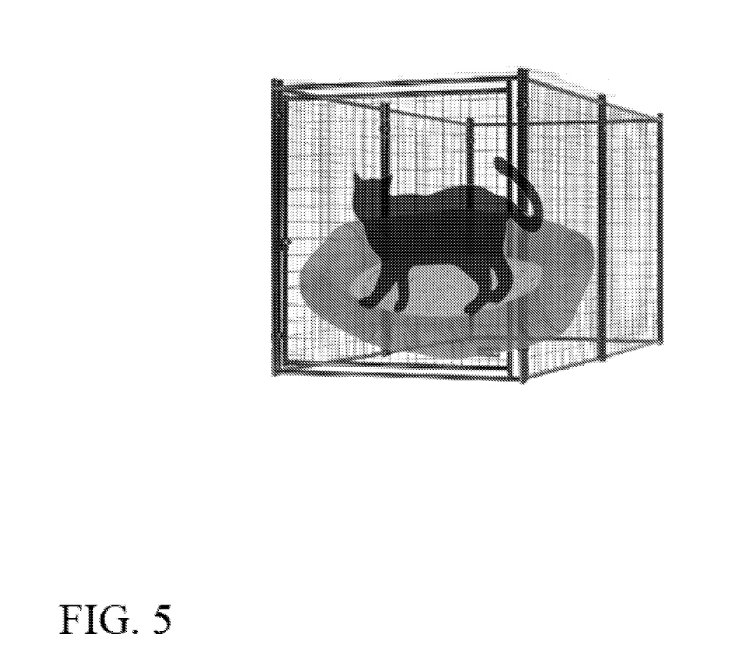

What the invention claimed is:

1. A flea trap containing a fake animal with fur. The fur contains poison which kills the fleas. Under the fur are small vibrators which make the fur vibrate, attracting fleas.

2. An invention as in claim 1 however the fake animal has a pump in it which causes it to puff up and down which attracts the fleas.

3. An invention as in claim 1-2 however the animal is a silhouette.

4. An invention as in claim 1-3 however there is a heat strip on the animal. This heat strip attracts the fleas.

5. An invention as in in claim 4 however the animal contains led eyes which attract the fleas.

6. An invention as in claim 4 however it contains UV lights which also attract the fleas.

7. An invention as in claim 4 however there is a sticky substance in the area around the animal which captures and immobilizes the fleas.

8. An invention as in claim 4 however there is diatamatious earth on the outside of the sticky substance, so it prevents extra substances sticking to the trap.

9. An invention as in claim 4 however there is a cage around the animal which prevents other animals from getting in the trap, but allows fleas to enter.

10. An invention as in claim 4 however the animal produces co2with titanium dioxide.
